(19) United States
(12) Patent Application Publication
(10) Pub. No.: US 2024/0117970 A1
(43) Pub. Date: Apr. 11, 2024

(54) PORTABLE OPERATING DEVICE FOR CONTROLLING A COOKING APPLIANCE FROM DIFFERENT OPERATING POSITIONS, AND COOKING APPLIANCE SYSTEM

(71) Applicant: BORA - Vertriebs GmbH & Co KG, Niederndorf (AT)

(72) Inventors: Julian SCHMICKAL, Niederndorf (AT); Michael JUNGMANN, Niederndorf (AT); Christof DESSL, Niederndorf (AT); Julia TÜCHLER, Niederndorf (AT); Kay SCHUSTER, Niederndorf (AT)

(21) Appl. No.: 18/547,345

(22) PCT Filed: Feb. 23, 2022
(86) PCT No.: PCT/EP2022/054548

§ 371 Date: Aug. 22, 2023

(30) Foreign Application Priority Data
Feb. 25, 2021 (DE) 10 2021 201 800.9
Feb. 25, 2021 (DE) 10 2021 201 801.7

(51) Int. Cl. F24C 7/08; H05B 6/06; H05B 6/12

(52) U.S. Cl. CPC F24C 7/083; H05B 6/062; H05B 6/1236; F24C 15/2042

(57) ABSTRACT

A portable operating device for controlling a kitchen appliance from different operating positions having a base body, at least one control element, which is displaceable relative to the base body, for the user to input control information, at least one sensor for detecting a relative movement between the at least one control element and the base body, and a communication unit which is connected to the at least one sensor in a signal-transmitting manner in order to wirelessly transmit, to the kitchen appliance, control information which correlates with the relative movement.

### CROSS-REFERENCES TO RELATED APPLICATIONS

This application claims the priority of German Patent Applications, Serial No. DE 10 2021 201 800.9 and DE 10 2021 201 801.7, filed Feb. 25, 2021, the contents of which are incorporated herein by reference in their entirety as if fully set forth herein.

### FIELD OF THE INVENTION

The invention relates to a portable operating device for controlling a kitchen appliance from different operating positions. The invention also relates to a kitchen appliance system comprising such a control device.

### BACKGROUND OF THE INVENTION

DE 10 2010 039 560 A1 discloses a portable operating apparatus for a hob, which is fixed by means of a magnet to an operating surface of a cooking product carrier that is equipped with sensors and can be rotated and tilted relative to the cooking product carrier to enter commands to control the hob. The disadvantage is that such an operating apparatus for controlling a hob must be arranged at a predetermined operating position, which reduces operating comfort.

### SUMMARY OF THE INVENTION

It is an object of the invention to provide an improved operating device for controlling a kitchen appliance, which in particular ensures especially convenient, efficient and safe operation of the kitchen appliance.

This object is achieved by a portable operating device for controlling a kitchen appliance from different operating positions, comprising a base body, at least one control element, which is displaceable relative to the base body, for the user to input control information, at least one sensor for detecting a relative movement between the at least one control element and the base body, and a communication unit which is connected to the at least one sensor in a signal-transmitting manner in order to wirelessly transmit, to the kitchen appliance, control information which correlates with the relative movement. A portable operating device for controlling a kitchen appliance can have a user interface for a user to input control information and a communication unit that is connected to the user interface in a signal-transmitting manner for wirelessly transmitting the control information to the kitchen appliance in order to ensure particularly convenient, efficient and safe operation of the kitchen appliance. Since the control information can be transmitted wirelessly to the kitchen appliance by means of the communication unit, the operating device can be arranged in different operating positions from which the kitchen appliance can be controlled by means of the operating device. For example, the operating device can be arranged on a cooking product carrier of a hob, on a kitchen worktop and/or on a kitchen table to control the kitchen appliance. The operating device can be flexibly positioned in the region of the user's current location. Complex operating surfaces that are equipped with sensors at each individual operating position for detecting the relative movement of the operating device can be avoided. In particular, the operating positions can be freely selectable and not predetermined by the position of a corresponding operating surface.

According to a particularly preferred, in particular independent, aspect of the invention, the user interface may comprise at least one control element that is displaceable relative to the base body for the user to input control information. Preferably, the user interface further comprises at least one sensor for detecting a relative movement between the at least one control element and the base body. For wireless transmission of the control information which correlates with the relative movement to the kitchen appliance, the at least one sensor may be connected to the communication unit in a signal-transmitting manner. The control element, which can be displaced relative to the base body, ensures a particularly intuitive input of user commands and thus further increases the ease of use. The displaceability of the at least one control element relative to the base body enables control inputs to be made by displacing the control element while the base body remains fixed, in particular relative to the kitchen appliance. Advantageously, this ensures that the orientation of the base body relative to the user can be maintained unchanged throughout the control input. A preferred orientation of the base body relative to the user, which is particularly advantageous, for example, due to the shape of the base body and/or due to visual information that is displayed on the base body, can thus remain unchanged.

According to a particularly preferred, in particular independent, aspect of the invention, the portable operating device may comprise at least one heat protection means in order to protect the operating device from harmful heat input from the environment. Preferably, the heat protection means is designed to protect the operating device from heat input via hot surfaces on which the operating device is accidentally placed, for example. The heat protection means can be designed as an active heat protection means with at least one electrical consumer or as a passive heat protection means without a consumer, in particular an electrical consumer. The protection against harmful heat input is preferably provided by the heat protection means not merely once, but repeatedly, in particular continuously and/or without replacement of the heat protection means. The at least one heat protection means advantageously ensures that a base body, in particular a housing and/or a supporting structure, and/or electronic components, such as a sensor, a display means and/or an actuator, are not damaged by excessive heat input from the environment. Here, heat is understood to mean in particular temperatures of up to 100° C., in particular up to 150° C., in particular up to 200° C., in particular up to 250° C., in particular up to 350° C., in particular up to 500° C. The operating device can thus be operated in a particularly robust and reliable manner.

The control information is understood to be information, in particular data and/or signals, comprising control commands for controlling the kitchen appliance and/or status information about the kitchen appliance, in particular about the operating status.

The portable design of the operating device means that it can be displaced manually by the user between the different operating positions. Preferably, the portable operating device has a mass in the range of 0.05 g to 5 kg, in particular 0.2 kg to 2 kg.

The portable operating device preferably has at least one electrical consumer, in particular an electronic component. The consumer can, for example, be a sensor and/or a user interface or be coupled to a user interface. The operating device can have a switch, in particular a button, in order to switch the operating device on and off, in particular to interrupt the power supply to the at least one electrical consumer.

The portable operating device may have an interface for the wired transmission of data and/or power. The interface can have a plug and/or a socket and/or part of a spring contact connection, in particular a spring contact pin connection. Preferably, the interface and/or the switch are designed to be splash-proof, in particular waterproof. For this purpose, the switch can be arranged behind a reversibly deformable region of the housing. The interface can be sealed, in particular closed, by means of a sealing element.

The user interface can have, in particular for entering control information, at least one switch, in particular a button, a touch-sensitive sensor, in particular a sensor film, and/or a vibration motor, in order to output haptically detectable signals and/or a loudspeaker in order to output acoustic signals.

The control element and the sensor may be part of a user interface for the user to input control information. The sensor for detecting the relative movement between the at least one control element and the base body may comprise a light barrier and/or a Hall sensor and/or a potentiometer. The sensor can be designed as a linear encoder or as a rotary encoder.

The communication unit can have a radio interface, in particular a Bluetooth interface, in particular a Bluetooth low-energy interface, and/or a Wifi interface and/or a 433 MHz interface and/or a ZigBee interface and/or an RFID interface, and/or an infrared interface. Preferably, the communication unit is designed for the wireless transmission of the control information, in particular in an obstacle-free environment, over a distance of at least 1 m, in particular at least 2 m, in particular at least 5 m, in particular at least 10 m, in particular at least 20 m, and/or a maximum of 25 m, in particular a maximum of 10 m, in particular a maximum of 5 m, in particular a maximum of 2 m. The communication unit is preferably designed to determine a distance to the communication partner based on the signal strength. In particular, the operating device or the communication partner, in particular a communication partner of the kitchen appliance, can be designed to limit the controllability of the kitchen appliance, in particular the scope of control functions that can be set by means of the operating device, in dependence on the signal strength. The specified range for the wireless connection ensures a high resolution of the signal strength over the distance to the communication partner. Thus, the controllability can be precisely adjusted based on the distance. In addition, interference due to signal overlaps is avoided as far as possible.

According to a further aspect of the invention, the operating device may be designed to control at least two, in particular at least three, in particular four kitchen appliances, and/or a maximum of two kitchen appliances, in particular a single kitchen appliance, simultaneously. The communication unit may be configured to establish a wireless connection for transmitting the control information simultaneously to at least two, in particular at least three, kitchen appliances, in particular communication partners. Several wireless data connections that are formed simultaneously can be established via a single, several identical or different interfaces, in particular a Bluetooth interface and a Wifi interface. For example, the connection to a kitchen appliance that is designed as a hob system can be established via a Bluetooth interface and a connection to a kitchen appliance that is designed as an oven can be established via a Wifi interface.

The communication unit and/or the communication partner of the kitchen appliance are preferably designed so that possible operating positions for controlling the kitchen appliance are exclusively within an operating radius in a range of 0.5 m to 20 m, in particular 1 m to 15 m, in particular 2 m to 10 m, around the kitchen appliance, in particular the communication partner. This allows the kitchen appliance to be controlled by means of the operating device in a particularly flexible manner, wherein interference from or to other wireless communication links is reduced.

According to one aspect of the invention, the operating device may be configured to connect to the Internet directly or indirectly, in particular via the kitchen appliance, in particular by means of the WiFi interface. For example, the operating device can be configured to obtain and/or install online updates and/or cooking recipes from an online server.

According to one aspect of the invention, the operating device has at least one processor for electronic data processing, in particular for processing the control information and/or controlling electrical and/or electronic components of the operating device. The processor is preferably in signal connection, in particular wired signal connection, with the user interface, in particular the sensor, and the communication unit. Preferably, the processor has a signal connection, in particular a wired signal connection, with all electrical and/or electronic components of the operating device.

According to a further aspect of the invention, the control element has knurling for non-slip operability by hand. The control element may also have an engagement, in particular a groove, in particular a ring-shaped circumferential groove, and/or a recess and/or a concave region for improved gripping. The knurling and/or the engagement may be arranged on an outer side of the control element. The control element may in particular have a substantially rotationally symmetrical circumference. It may preferably have one or more symmetry-breaking elements. This improves the intuitive detection of the position and/or displacement of the control element.

According to one aspect of the invention, the operating device may comprise a cooking product sensor for detecting a physical characteristic, in particular the temperature and/or the optical appearance, of the cooking product. The cooking product sensor may be configured as a temperature sensor and/or a sensor, in particular an optical sensor, in particular a camera, in particular for spectral analysis. The cooking product sensor is preferably arranged on an underside, in particular on the side of a positioning surface of the operating device. The operating device can be placed on a supporting body, for example on a kitchen worktop, via the positioning surface in order to operate the kitchen appliance. A sensing direction of the cooking product sensor preferably points downwards in a vertical direction. The vertical direction corresponds to the direction of gravity. In particular, it runs perpendicularly to the kitchen worktop. Advantageously, a vertical sensing direction ensures that the cooking product sensor is arranged opposite a top side of the operating device used to output visual information. The cooking product sensor can also have a sensing direction with a horizontal component. This makes it possible, for example, to detect the position of the pots and/or other components of the hob system.

According to one aspect of the invention, electrical or electronic components, in particular the communication unit and/or the processor and/or the sensor, in particular all electrical or electronic components of the operating device, can be attached exclusively to the base body or exclusively to the control element. Advantageously, this makes it possible to avoid the need for electrical conduction between the base body and the control element, which is displaceable relative thereto.

The operating device can have an output installation to output information. The operating device can in particular have at least one, in particular at least two, loudspeakers, in particular a beeper and/or resonance loudspeaker and/or a vibration loudspeaker. Resonance or vibration loudspeakers are loudspeakers which excite a body, in particular a table top, adjacent thereto to vibrate in order to emit more sound, in particular which do not have their own loudspeaker membrane. The operating device can be designed to output acoustic signals, such as control information and/or status information of the kitchen appliance and/or a confirmation signal for a user input and/or a warning signal and/or music. The operating device can also have a visual output installation, in particular in the form of a display and/or a screen.

Recipe information and/or cooking instructions can be output visually and/or acoustically via the output installation.

According to another aspect of the invention, the operating device comprises a data memory. A computer program for controlling the operating device and/or the kitchen appliance can be stored on the data memory. Preferably, the data memory has a size of at least 1 GB, in particular at least 2 GB, in particular at least 4 GB. Music and/or recipes and/or cooking instructions can be stored and/or storable on the data memory. The data memory can be physically replaceable. The data memory may also be permanent, i.e. non-exchangeable. Its content is preferably at least partially exchangeable. In particular, it may be replaceable by the user. It is also possible to design the data memory such that it can only be overwritten after a specific activation, for example using a code or a physical activation element. This makes it possible to reserve specific changes exclusively for authorized persons, for example customer service.

One, in particular independent, aspect of the invention relates to a computer program product for operating the operating device. Preferably, the computer program is stored on the data memory. Preferably, the computer program is further configured comprising at least one of the features described in connection with the operating device.

The computer program product may comprise control sequences to control the operating device and/or the kitchen appliance and/or to control user actions. In particular, it may also include control sequences to implement cooking recipes.

According to a further aspect of the invention, the at least one control element is rotatably mounted relative to the base body. The relative movement between the at least one control element and the base body that can be detected by the at least one sensor can be a rotary movement. The control element is preferably mounted relative to the base body by means of a plain bearing or a ball bearing, in particular without metallic components. The control element can be rotatable relative to the base body over an angle of rotation of at least 90°, in particular of at least 270°, in particular of at least 720°, and/or a maximum of 360°, in particular a maximum of 270°, in particular a maximum of 90°. The sensor can be designed to detect the relative movement over the entire range of movement. The rotatable control element can be used in a particularly intuitive and time-efficient manner, in particular for selecting list items and/or entering power levels.

According to a further aspect of the invention, the at least one control element, in particular in a plan view, is round, in particular circular, and/or ring-shaped, in particular circular ring-shaped, and/or rotationally symmetrical. A main dimension, in particular an outer diameter, of the control element is preferably in a range from 40 mm to 120 mm, in particular from 50 mm to 100 mm, in particular at 90 mm.

According to a further aspect of the invention, the at least one control element is reversibly removable from the base body. Advantageously, this enables the operating device to be cleaned in a simple manner. The control element is preferably removable from the base body without tools. For this purpose, the control element can be attached to the base body by means of a form-fit connection, in particular a latching connection. The base body can be configured in two parts, for example, wherein the control element is held reversibly between the respective parts of the base body. The control element can also be attached to the base body by means of a force-fit connection, in particular a screw connection.

The operating device, in particular the base body and/or the control element, may be waterproof, in particular dishwasher-proof, and/or temperature-resistant, in particular up to at least 100° C., in particular up to at least 150° C., in particular up to at least 300° C.

According to a further aspect of the invention, a sealant is provided between the base body and the at least one control element for sealing a gap between the base body and the control element. Ingress of contaminants between the base body and the control element can thus be prevented.

According to a further aspect of the invention, the operating device comprises at least one display means for the visual output of information. The display means preferably comprises a screen, in particular a touch-sensitive screen. The screen may be configured in the form of an LED screen, in particular an OLED screen. The display means may also have individual light sources, in particular LEDs. Preferably, the display means is designed to display symbols and/or digits and/or letters. The display means can be in signal connection with an ambient light sensor for automatic adjustment of the display brightness. The display means can in particular be a component of the output installation.

Preferably, the display means comprises a cover which overlaps the display means for protection. The cover can comprise glass, in particular scratch-resistant glass and/or a transparent, in particular glass-like plastic material. Preferably, the cover has a tint, in particular a black tint. The display means is preferably only visible through the cover in the activated state.

The dimensions, in particular the outer diameter, of the cover preferably correspond to the dimensions, in particular the outer diameter, of the control element. The display surface, in particular the recess of a display mask via which visual information can be output, is preferably round, in particular circular, in a plan view. A main dimension, in particular a diameter, of the display surface is preferably in a range from 40 mm to 100 mm, in particular from 50 mm to 90 mm, in particular it is 85 mm. A difference between the main dimension, in particular the outer diameter, of the control element and the main dimension, in particular the diameter, of the display surface is preferably a maximum of 40 mm, in particular a maximum of 20 mm, in particular a maximum of 10 mm.

Preferably, an outline of the control element encloses a geometric centroid of the at least one display means, in particular the display surface, in a plan view. The control element can be arranged concentrically to the display means, in particular the display surface. The axis of rotation of the control element is preferably oriented perpendicularly to the surface, in particular the display surface, of the display means. The control element can overlap the display means along the axis of rotation and/or be arranged below the display means.

According to a further aspect of the invention, the operating device comprises a microphone for the input of acoustic signals, in particular for voice input. The computer program stored on the data memory can be designed to evaluate voice commands. Alternatively, a control device of the kitchen appliance or an online server that is in signal connection with the operating device may be designed to evaluate the voice input. Preferably, the operating device and/or the kitchen appliance can be controlled by voice input via the at least one microphone. The operating device, in particular the microphone, can also be designed to conduct telephone calls, in particular Voice Over IP telephone calls.

According to a further aspect of the invention, the at least one touch-sensitive sensor, in particular the touch-sensitive screen of the display means and/or the processor and/or the computer program are configured to detect gestures input via the touch-sensitive sensor.

According to a further aspect of the invention, the at least one control element is mounted on the base body so as to be translationally displaceable relative to the base body. The relative movement between the control element and the base body that can be detected by the sensor can be a translatory movement. The sensor may be designed as a linear encoder and/or as a rotary encoder and/or as a feeler. Preferably, the control element is displaceable relative to the base body over a path length in a range from 0.2 mm to 100 mm, in particular from 0.5 mm to 50 mm, in particular from 1 mm to 10 mm. Preferably, the path length for which the control element is displaceable relative to the base body is a maximum of 5 mm, in particular a maximum of 2 mm, in particular a maximum of 1 mm. The path along which the control element is translationally displaceable relative to the base body can follow a curve, in particular a straight line, which runs in particular parallel to the surface of the display means and/or tangentially to a curved surface of the operating device.

According to a further aspect of the invention, the operating device comprises an orientation sensor to determine the orientation of the operating device, in particular the orientation relative to a kitchen room and/or kitchen furniture and/or the kitchen appliance. The orientation sensor may comprise a magnetic sensor, in particular for detecting the earth's magnetic field or the magnetic field of at least one reference encoder, in particular a reference magnet. The at least one reference encoder can be designed as a permanent magnet and/or as an electromagnet. The kitchen appliance and/or the kitchen furniture may have the at least one reference magnet. Alternatively, the operating device may have a freely positionable reference magnet. The orientation sensor may also be designed as a radio receiver for detecting a radio signal. The orientation of the operating device can be determined depending on the nature of the radio signal. Preferably, the orientation sensor has a directional antenna for this purpose. The operating device and/or the kitchen appliance and/or the kitchen furniture can have a reference encoder for transmitting an electromagnetic reference signal.

According to a further aspect of the invention, the operating device, in particular the computer program, is configured to calibrate the orientation of the operating device by means of the orientation sensor. The calibration process may comprise at least one of the steps of prompting the user to align the operating device in a preferred orientation and/or detecting the preferred orientation by means of the orientation sensor and/or storing the detected orientation as a reference orientation and/or detecting the alignment of the information output via the display means and/or storing the alignment of the information output via the display means as a reference alignment and/or repeatedly detecting the orientation of the operating device, in particular continuously, and/or determining a difference between the detected orientation of the operating device and the reference orientation and/or changing the alignment of the visual information output via the display means on the basis of this difference and/or on the basis of the difference between the current alignment and the reference alignment, in particular such that the alignment of the displayed information corresponds to the reference alignment. Advantageously, this ensures that the alignment of the information displayed via the display means always corresponds to the reference alignment preferred by the user, irrespective of the orientation of the operating device, in particular in the event of a change in the orientation of the operating device.

According to a further aspect of the invention, the operating device may comprise an energy storage device for storing electrical energy. The energy storage device is preferably a chemical energy storage device, in particular an accumulator, in particular a lithium-polymer accumulator and/or a battery, and/or a capacitor. Advantageously, this enables the operating device to be handled in a particularly flexible manner. The energy storage device preferably has a capacity of at least 0.1 kJ, in particular at least 1 kJ, in particular at least 10 kJ, in particular at least 50 kJ, in particular at least 100 kJ, and/or a maximum of 50 kJ. The energy storage device is preferably in energy-transmitting connection with the processor and/or the communication unit and/or the sensor.

The operating device can be designed such that the kitchen appliance controlled with the help thereof remains in the current operating state or switches off automatically if the residual energy in the energy storage device falls below a predefined limit value, for example 5% of the maximum storable energy. This can happen immediately or after a predefined transition time during which the kitchen appliance can still be controlled by the operating device. In particular, it can be provided that the user can choose between these different options.

Preferably, the kitchen appliance can be operated manually regardless of the status of the operating device, in particular regardless of the charging status of the energy storage device.

According to a further aspect of the invention, the operating device comprises an energy receiver for wirelessly receiving energy and/or for supplying the operating device, in particular the energy storage device, with electrical energy. The energy receiver may be designed for wireless absorption of electromagnetic energy, in particular as a coil. The energy receiver is preferably in energy-transmitting connection with the energy storage device.

Preferably, the energy receiver is designed to receive electrical energy from a transmitter of the kitchen appliance, in particular from induction cooking plates.

According to another aspect of the invention, the operating device comprises an electric actuator to cause a force and/or a moment acting between the at least one control element and the base body. The electric actuator is preferably configured to output forced feedback signals. Forced feedback signals are signals that can be haptically detected by the user, in particular signals that are coupled to a control input and/or a control state and/or a control state change. The electric actuator can be in signal connection with the processor for corresponding control.

Preferably, the processor and/or the electric actuator and/or the computer program are designed so that the haptically detectable signals transmitted to the control element are coupled to signals which are output in parallel, in particular simultaneously, via the display means and/or are coupled to the change between menu items and/or list elements and/or control parameters and/or to reaching a list end point. Advantageously, this ensures that the user receives haptic feedback on control inputs. In particular, the change between list elements and/or menu items and/or control parameters can be fed back via a force applied to the control element and/or a moment applied thereto. The operation of the operating device can thus be carried out particularly intuitively or without continuous eye contact with the display means.

The processor and/or the electric actuator and/or the computer program can also be designed to simulate latching points, in particular with a stable state of equilibrium, along the relative movement between the control element and the base body.

According to another aspect of the invention, the operating device may comprise an adhesive means for reversibly arranging the operating device in a non-slip manner on a surface, in particular a flat surface and/or a smooth surface, in particular a glass surface. The adhesive means may comprise a fastener button and/or a velcro element and/or a suction cup and/or a silicone layer. The silicone layer increases the friction to the underlying supporting body. The supporting body can be, for example, a cooking product carrier of the hob, in particular a glass-ceramic plate, and/or a kitchen worktop. A positioning surface to contact the supporting body preferably has a concave portion. This allows a negative pressure to be created between the positioning surface and the supporting body and improved adhesion to be achieved.

According to a further aspect of the invention, the operating device may comprise at least one heat protection means for protecting the operating device from harmful heat input from the environment, in particular from a supporting body on which the operating device is placed. The heat protection means can have at least one active heat protection element, in particular an electrical and/or electronic consumer, and/or a passive heat protection element, in particular a thermal insulator. The heat protection means can be permanently connected to the operating device, in particular to the base body.

According to one aspect of the invention, the at least one heat protection means may comprise at least one heat protection body to thermally decouple, in particular thermally insulate, the base body from the environment, in particular from the supporting body. In particular, the heat protection means may comprise the positioning surface to contact the supporting body, thereby ensuring protection against hot surfaces. Preferably, the heat protection means comprises a single or at least one, in particular at least two, in particular at least three of the heat protection bodies. The heat protection body may be designed to shield thermal radiation.

According to a further aspect of the invention, the at least one heat protection body comprises a material, in particular the heat protection body consists of a material which is heat resistant up to at least 150° C., in particular at least 200° C., in particular at least 250° C., in particular at least 300° C.

Preferably, the at least one heat protection body may comprise, in particular consist of, a material having a thermal conductivity of a maximum of 5 W/mK, in particular a maximum of 2 W/mK, in particular a maximum of 1 W/mK, in particular a maximum of 0.5 W/mK, in particular a maximum of 0.25 W/mK. The material may comprise ceramic, in particular glass ceramic and/or a metal and/or a heat-resistant plastic material, in particular silicone and/or PEEK.

The thickness of the heat protection body, in particular between the positioning surface and the base body and/or the at least one control element, is preferably in a range from 0.5 mm to 10 mm, in particular in a range from 1 mm to 5 mm, in particular in a range from 2 mm to 4 mm.

According to another aspect of the invention, the at least one heat protection body may be replaceably attached to the base body. In this way, the heat protection body can be cleaned particularly easily. In particular, the heat protection body can be replaced after damage, in particular thermal damage.

According to a further aspect of the invention, the at least one heat protection body comprises the adhesive means to reversibly arrange the operating device on a surface, in particular a glass surface, in a non-slip manner.

According to a further aspect of the invention, the at least one heat protection means may comprise a position sensor to determine the position of the operating device relative to the cooking appliance. The position sensor may be configured to detect an electromagnetic signal and/or a magnetic signal and/or as a Hall sensor and/or as a magnetic sensor.

Preferably, the position sensor is designed to detect a reference signal from a reference encoder of the kitchen appliance and/or the kitchen furniture and/or a freely positionable reference encoder. For example, the position sensor can detect a reference signal, in particular the signal strength and/or the signal orientation of the reference signal, to determine a distance to the kitchen appliance, in particular to hot plates of a hob. The position sensor can also be designed to detect electrically conductive materials, in particular, for example, energized conductor tracks. Preferably, it can be detected by means of the position sensor whether the operating device is arranged on the hot plates of a hob or not. Advantageously, this means that the positioning of the operating device on a hot plate can be indicated to the user, for example by emitting a warning signal, and can thus be avoided.

According to another aspect of the invention, the at least one heat protection means comprises a temperature sensor. The temperature sensor is preferably arranged on an underside of the operating device. A sensing direction of the temperature sensor may be oriented downward in a vertical direction. In particular, the temperature sensor can be designed to detect a surface, in particular the supporting body, on which the operating device is placed. The temperature sensor can be designed for contacting or contactless detection of the temperature of a surface. In particular, the temperature sensor can be designed as an infrared sensor. The temperature sensor is preferably attached to the base body and/or to the heat protection body. Preferably, the temperature sensor is in signal connection with a means for the output of a warning signal to the user. Advantageously, this allows the user to be warned when or before the operating device is placed on a hot surface. Preferably, the detection range of the contactless measurement by the temperature sensor is at least 50 mm, in particular at least 200 mm.

According to a further aspect of the invention, the operating device comprises a signal transmitter to warn the user of the harmful heat input from the environment. The signal transmitter may be configured to output an acoustic and/or visual and/or haptically detectable signal. In particular, the signal transmitter may comprise the display means and/or the loudspeaker and/or the vibration motor.

It is another object of the invention is to provide an improved kitchen appliance system which is in particular especially intuitive, flexible, time-efficient and convenient to use.

This object is achieved by a kitchen appliance system comprising at least one kitchen appliance, in particular in the form of a cooking appliance for heating cooking products, and at least one portable operating device according to the above description. The cooking appliance may be an oven, in particular a baking oven and/or a steam cooking oven, and/or a hob and/or a warming drawer. Preferably, the respective kitchen appliance has a control device to exchange data with the operating device, in particular to send and/or receive data.

The kitchen appliance can have the at least one reference encoder to provide a reference signal that can be detected by the orientation sensor and/or the position sensor. The kitchen appliance can be designed to be controlled by the operating device with regard to all or a reduced part of its available control scope. In particular, the control scope released to the operating device can be changed dynamically, in particular in dependence on the distance between the operating device and the kitchen appliance and/or the signal strength of the wireless data connection.

The at least one kitchen appliance may have a kitchen appliance orientation sensor and/or a kitchen appliance position sensor to detect the orientation and/or the position of the operating device relative to the kitchen appliance. Preferably, the kitchen appliance is designed for wireless transmission of corresponding measurement signals of the kitchen appliance orientation sensor and/or the kitchen appliance position sensor to the operating device. These measurement signals can be used in accordance with the measurement signals of the orientation sensor and/or the position sensor of the operating device. This makes the operating device particularly safe and robust in operation and ensures convenient control of the respective kitchen appliance.

According to one aspect of the invention, the kitchen appliance has a user interface attached thereto, in particular rigidly, and in particular not detachable without tools and/or not non-destructively. Preferably, control commands from this user interface are given priority over control commands from the portable operating device.

According to another aspect of the invention, the kitchen appliance system comprises at least one kitchen appliance configured as an extractor fan apparatus. The extractor fan apparatus is preferably designed to extract cooking fumes downwards. The extractor fan apparatus may be a component of a hob system comprising a hob. The extractor fan apparatus may have a single fan or at least one fan, in particular at least two fans, in particular at least three fans.

The hob preferably has at least two, in particular at least three, in particular at least four, hot plates, in particular induction cooking plates.

A cooking product carrier of the hob can have a perforation through which the cooking fumes are sucked into the extractor fan apparatus. This perforation preferably forms the inflow opening of the extractor fan apparatus. A cross-sectional area of the inflow opening is preferably oriented parallel to a horizontal plane.

The hob system can have an overall height of a maximum of 250 mm, in particular a maximum of 200 mm, in particular a maximum of 150 mm, in particular a maximum of 100 mm. The overall height is preferably measured between the upper side of the cooking product carrier and the underside of a fan and/or a negative pressure duct portion of the extractor fan apparatus.

Further features, details and advantages of the invention will be apparent from the following description of an embodiment example based on the figures.

### BRIEF DESCRIPTION OF THE FIGURES

FIG. 1 shows a perspective illustration of a kitchen appliance system comprising two kitchen appliances designed as cooking appliances for heating cooking products and a portable operating device to control the kitchen appliance from different operating positions,

FIG. 2 shows a perspective illustration of the portable operating device in FIG. 1, comprising a base body, a display means attached to the base body for the visual output of information and a ring-shaped control element, which is displaceable relative to the base body, for the user to input control information,

FIG. 3 shows a perspective illustration of the ring-shaped control element in FIG. 2, wherein the control element has circumferential knurling for non-slip actuation by the user,

FIG. 4 shows a front view of the portable operating device in FIG. 1, with the control element and an adhesive means for reversible, non-slip arrangement of the operating device on a glass surface,

FIG. 5 shows a bottom view of the portable operating device in FIG. 1, with the adhesive, a switch for switching the operating device on and off and an optical sensor arranged behind a viewing opening,

FIG. 6 shows an exploded view of the operating device in FIG. 1 from the side, and

FIG. 7 shows a schematic plan view of a base body element of the operating device according to FIG. 1.

### DESCRIPTION OF THE PREFERRED EMBODIMENT

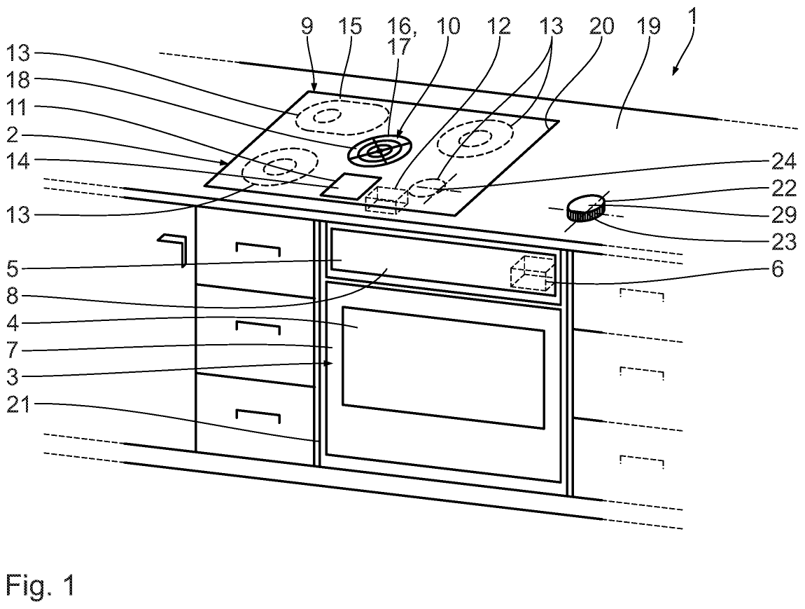

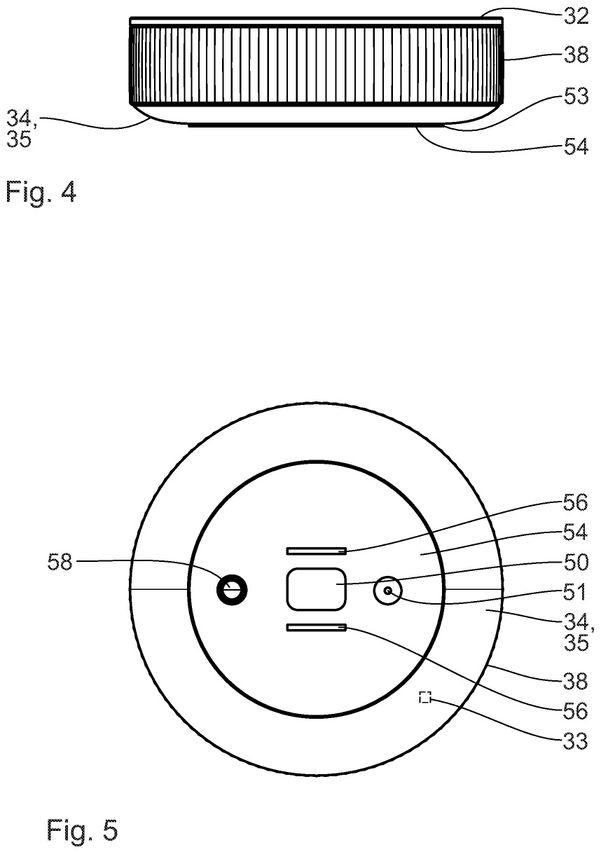

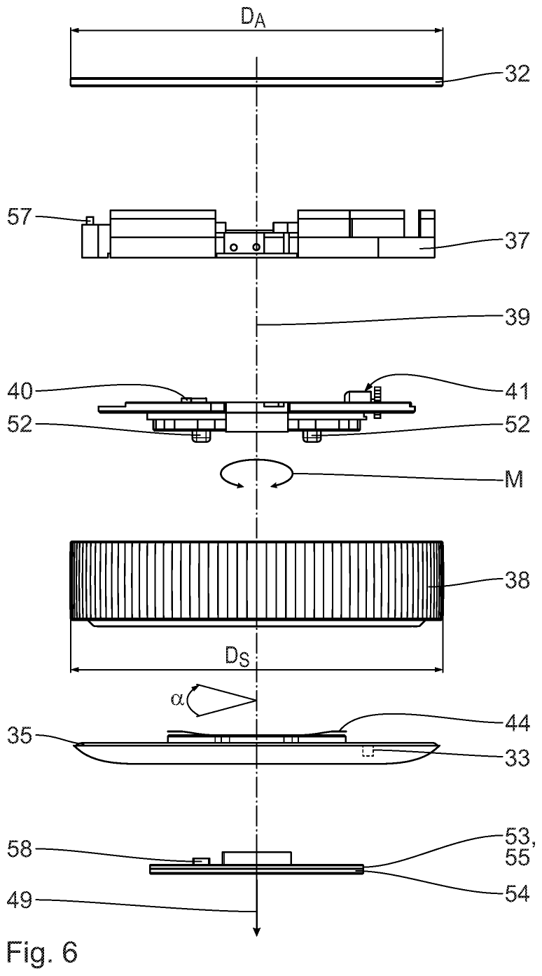

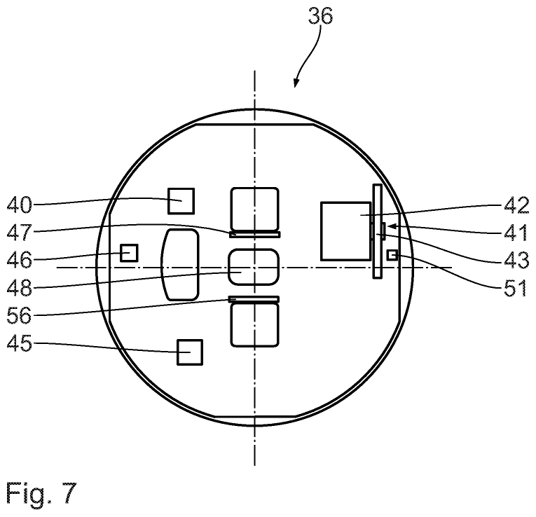

With reference to FIG. 1 to FIG. 7 an embodiment example of a kitchen appliance system 1 is described. The kitchen appliance system 1 comprises two kitchen appliances which are designed as a hob system 2 and as an oven 3, in particular as a steam cooking oven.

The oven 3 comprises a cooking chamber 4 into which cooking products can be placed to be heated, an oven user interface 5 to exchange information with the user, in particular for the input and output of information, and an oven control device 6 to control the oven 3. The cooking chamber 4 can be reversibly closed by means of a cooking chamber door 7. The oven user interface 5 comprises a touch-sensitive screen 8, in particular including a capacitive film sensor to detect a touch and an OLED display. The oven control device 6 is in signal-transmitting connection, in particular via a wired connection, with the oven user interface 5 and a heating installation, not shown, to heat the air inside the cooking chamber 4.

The hob system 2 has a hob 9, an extractor fan apparatus 10, a hob user interface 11 and a hob control device 12. The hob 9 is configured to include four hot plates for heating cooking products placed thereon. The hot plates 13 are induction cooking plates. The hob user interface 11 has a touch-sensitive screen 14 to exchange information with the user. The hob control device 12 is configured to control the hob 9 and the extractor fan apparatus 10. In particular, the hob control device 12 has a signal connection, in particular a wired signal connection, with the hob 9, in particular the hot plates 13, the extractor fan apparatus 10 and the hob user interface 11.

The hob system 2 comprises a cooking product carrier 15 which is designed as a glass-ceramic plate. The cooking product carrier 15 is penetrated by an extraction recess 16 through which cooking fumes are extracted downwards by means of the extractor fan apparatus 10. The extraction recess 16 forms an inlet opening 17 of the extractor fan apparatus 10 through which the cooking fumes can flow into the extractor fan apparatus 10.

An inlet grid 18 is inserted into the inlet opening 17. The inlet grid 18 has flow guiding elements that are arranged concentrically to each other. The inlet grid 18 is reversibly removable from the extractor fan apparatus 10 in an upward direction.

The hob system 2 is attached to a kitchen worktop 19, in particular inserted into a panel recess 20 which penetrates the kitchen worktop 19. The cooking product carrier 15 is arranged flush with the kitchen worktop 19, in particular an upper side of the kitchen worktop 19. The kitchen worktop 19 rests on a kitchen base cabinet 21. The oven 3 is built into the kitchen base cabinet 21.

The kitchen appliance system 1 has an operating device 22. The operating device 22 is shown in FIG. 1 in a first operating position 23, in which it is arranged on the kitchen worktop 19. The operating device 22 can be flexibly moved between different operating positions 23, 24. In particular, the operating device 22 is designed to control the respective kitchen appliance 2, 3 in the different operating positions 23, 24. For example, the operating device 22 can be arranged in a second operating position 24 on the cooking product carrier 15.

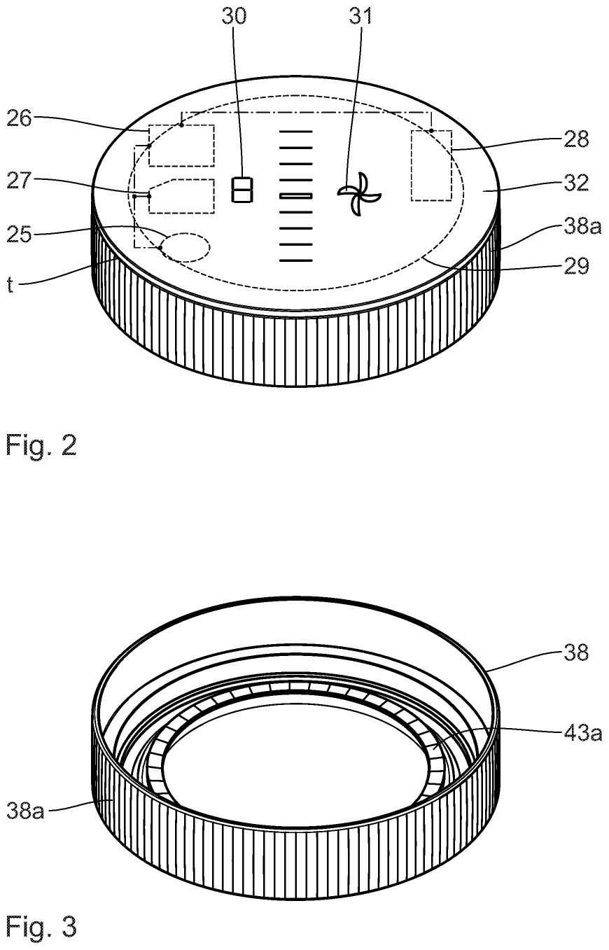

The portable operating device 22 is shown in further detail in FIG. 2 to FIG. 7. The operating device 22 has a communication unit 25 for wireless exchange of information, in particular status and control information, with the hob system 2, in particular the hob control device 12, and the oven 3, in particular the oven control device 6. The communication unit 25 has a Wifi interface and a Bluetooth interface. The operating device 22 is connected to the oven control device 6 by wireless signal transmission via the Wifi interface. The operating device 22 is connected to the hob control device 12 by wireless signal transmission via the Bluetooth interface. The exchange of information includes sending and receiving information.

The operating device 22 has a processor 26 for processing information, a data memory 27 for storing information and an energy storage device 28 for storing electrical energy. The energy storage device 28 is designed as a chemical energy storage device, in particular as an accumulator, in particular as a lithium-polymer accumulator. The processor 26 is in signal-transmitting connection, in particular wired connection, with the data memory 27 and the communication unit 25. For the supply with electrical energy, the processor 26 is connected to the energy storage device 28 in an energy-transmitting manner.

For the visual output of information to the user, the operating device 22 has a display means 29 in the form of a screen, in particular an OLED screen. The display means 29, in particular the screen, is round, in particular circular, in a plan view. The display means 29 has 100 to 2,000, in particular 250 to 1,100, in particular 512, individually controllable pixels along its main extension direction, in particular over its diameter.

The display means 29 is designed to display digits 30, symbols 31 and letters. The display means 29 is designed as a touch-sensitive screen. For this purpose, the display means 29 comprises a sensor film, in particular a capacitive sensor film, to detect a touch of the display means 29 with one or more fingers. The screen and the sensor film are in signal connection with the processor 26. The sensor film is round, in particular circular, in a plan view, corresponding to the screen.

The display means 29 comprises a cover 32. The cover 32 is made of scratch-resistant glass. The cover 32 is round, in particular circular, in a plan view. A diameter DA of the cover 32 is 90 mm.

For charging the energy storage device 28 with electrical energy, the operating device 22 has an energy receiver 33. The energy receiver 33 is designed to receive energy wirelessly, in particular as a coil for receiving electromagnetic energy. The energy storage device 28 is connected to the energy receiver 33 in an energy-transmitting manner, in particular in a wired manner. As an alternative or in addition to the design of the energy receiver 33 for wireless energy absorption, it can have a socket, in particular a USB connection or individual contacts, in particular arranged on a surface of the operating device 22, in particular to form a spring pin contact, for energy and/or data transmission.

The operating device 22 has a base body 34. The processor 26, the energy storage device 28 and the display means 29 with the cover 32 are attached, in particular rigidly attached, to the base body 34. The base body 34 comprises a plastic material, in particular ABS, PEEK or PP. The base body 34 is configured in multiple parts. The base body 34 comprises a first base body element 35, a second base body element 36 and a third base body element 37. The base body elements 35, 36, 37 are fastened, in particular rigidly, to one another, in particular screwed or latched together. The base body elements 35, 36, 37, in particular the first base body element 35 and the second base body element 36, are detachably connected to each other.

A control element 38 is displaceably attached to the base body 34. The control element 38 is rotatably mounted about an axis of rotation 39 relative to the base body 34. The axis of rotation 39 is oriented perpendicularly to a screen surface of the screen of the display means 29. In particular, the display means 29, in particular the screen surface and/or the cover 32, are arranged concentrically to the axis of rotation 39. The operating device 22 is designed to be essentially rotationally symmetrical to the axis of rotation 39.

The control element 38 is held in a form-fit manner between the first base body element 35 and the second base body element 36 and is rotatably mounted. The detachable connection between the first base body element 35 and the second base body element 36 ensures that the control element 38 can be reversibly removed from the base body 34.

Preferably, the control element 38 is removable from the base body 34 without tools.

The control element 38 is made of a metal, in particular aluminium. The control element 38 has a knurling 38a for non-slip gripping by hand. A diameter Ds of the control element 38 is 90 mm. In particular, the diameter Ds of the control element 38 corresponds to the diameter DA of the cover 32. The cover 32 preferably overlaps the control element 38. A gap t between the cover 32, in particular an underside of the cover 32, and the control element 38, in particular an upper side of the control element 38, is preferably a maximum of 1 mm, in particular a maximum of 0.5 mm, in particular a maximum of 0.2 mm, and/or at least 0.05 mm, in particular at least 0.1 mm, in particular at least 0.2 mm.

The operating device 22 has a sensor 40 to detect a relative movement between the control element 38 and the base body 34. The sensor 40 is designed as an optical rotary encoder, in particular as an incremental rotary encoder.

The communication unit 25 is connected in a signal-transmitting manner to the sensor 40 for wireless transmission, to the kitchen appliance 2, 3, of control information correlating with the relative movement. In particular, the sensor 40 is connected to the communication unit 25 via the processor 26.

The operating device 22 has an electric actuator 41 to effect a moment M acting between the control element 38 and the base body 34. The actuator 41 is in signal connection with the processor 26. The actuator 41 comprises an electric motor 42 and a pinion 43. The pinion 43 engages a ring gear 43a of the control element 38 for driving the control element 38 in rotation about the axis of rotation 39 relative to the base body 34.

By means of the electric actuator 41, latching points, menu items, menu end points and/or warning signals are preferably signalled to the user in a haptically detectable manner. The actuator 41 preferably acts along the displacement movement of the control element 38 relative to the base body 34.

The processor 26 and the actuator 41 are designed to output a signal that can be haptically detected by the user at the control element 38, in particular during actuation of the control element 38 by the user. In particular, the actuator 41 is designed as a forced feedback device. The haptically detectable signal is provided in the form of moments M between the control element 38 and the base body 34. The signal can, for example, indicate the change between different setting options, list elements and/or menu items, and/or signal the reaching of a setting limit, in particular an end of list and/or a limit value of a value range, and/or represent a warning notice.

Preferably, the actuator 41 is controlled by means of the processor 26 on the basis of a power applied to the actuator 41 and/or in dependence on the change in the relative arrangement between the control element 38 and the base body 34.

By means of the actuator 41, the control element 38 is rotated, in particular in a continuous movement, preferably by an angle of rotation a about the axis of rotation 39 in a range of 0.5° to 5°, in particular up to 3°.

The moment effected between the base body 34 and the control element 38 by means of the actuator 41 is preferably in a range from 0.005 Nm to 1 Nm, in particular from 0.05 Nm to 0.5 Nm.

The period of time over which the moment M is exerted on the control element 38, in particular without interruption, is preferably in a range of 0.1 s to 2 s, in particular in a range of 0.5 s to 1 s. Haptic signals exerted in this way for such short periods of time can be perceived particularly reliably.

Preferably, the processor 26 and the actuator 41 are designed to adjust the moment M in its strength, in particular continuously, and/or with regard to the direction of rotation.

The information that is output optically via the display means 29, in particular the screen, is preferably coupled with the information that is output haptically via the actuator 41. In particular, the output of corresponding information via the actuator 41 and via the display means 29 takes place to be temporally parallel. For example, a menu item and/or a list element can change via the display means 29, wherein the moment M is exerted on the control element 38 in a temporally parallel manner, in particular simultaneously.

The control element 38 can be displaced in the vertical direction, in particular along the axis of rotation 39, relative to the base body 34. By means of a spring element 44, the control element 38 is biased upwards in the vertical direction relative to the base body 34, in particular in the direction of the display means 29. A sensor 45 in the form of a feeler is designed to detect the translatory movement of the control element 38 relative to the base body 34 along the axis of rotation 39.

The operating device 22 has a microphone 46 for voice input. In particular, the operating device 22, especially the processor 26, is designed to enable voice control of the operating device 22 and/or the kitchen appliance 2, 3. A computer program for executing the voice recognition is stored on the data memory 27.

The operating device 22 further comprises an orientation sensor 47 to determine the orientation of the operating device 22, in particular relative to the kitchen room, the kitchen base cabinet 21, the kitchen worktop 19 and/or the respective kitchen appliance 2, 3. The orientation sensor 47 can be a magnetic field sensor, in particular for detecting a reference magnetic field, in particular the earth's magnetic field. The orientation that can be detected by the orientation sensor 47 concerns the orientation about the vertical axis, in particular about the axis of rotation 39.

According to an alternative embodiment, the cooking appliance system 1, in particular the kitchen appliance 2, 3, comprises a reference encoder, in particular a reference magnet, which can be detected by the orientation sensor 47 to determine the orientation of the operating device 22.

According to a further, alternative embodiment, the orientation sensor 47 is designed to detect an electromagnetic signal. The reference encoder may have one or more transmitters to output an electromagnetic signal. The orientation of the operating device 22 may be determined based on the signal strength of one or more signals from the reference encoder.

The processor 26 and/or a computer program stored on the data memory 27 are designed to execute a calibration process. Preferably, the user is prompted by a signal from the processor 26, in particular by a corresponding display on the display means 29, to align the operating device 22 in a preferred orientation about the vertical axis, in particular about the axis of rotation 39. The orientation of the operating device 22 is detected by means of the orientation sensor. The orientation is stored in the data memory 27 as a reference orientation. Furthermore, the alignment of the visual information output via the display means 29 is determined and stored as a reference alignment. The calibration process is completed.

The orientation of the operating device 22 is preferably continuously detected by the orientation sensor 47. A change of orientation, for example due to the rearrangement of the operating device 22 in another operating position 23, 24, can thus be determined. The processor 26 may be configured to adapt the alignment of the information output via the display means 29 according to the detected orientation, in particular in dependence on the difference between the detected orientation and the reference orientation and/or of the reference alignment. Preferably, the information displayed by the display means 29 is aligned such that it is aligned according to the reference alignment independently of the orientation of the base body 34. The functionality described above is particularly effective in the design of the operating device 22 with the circular display means 29, in particular the circular screen.

Alternatively or additionally, the kitchen appliance 2, 3 may have a kitchen appliance orientation sensor to detect the orientation of the operating device 22 relative to the kitchen appliance 2, 3. The orientation information can be transmitted from the kitchen appliance 2, 3 to the operating device 22 by means of the communication unit 25. The calibration process and/or the alignment of the information displayed via the display means 29 can be performed according to the orientation received from the kitchen appliance 2, 3 as described above.

The operating device 22 has an optical sensor 48, in particular a camera. The optical sensor 48, together with a computer program for image analysis stored on the data memory 27, enables automatic identification of objects, in particular ingredients of the cooking products. In particular, the optical sensor 48 and/or the computer program for image analysis are designed for spectral analysis of the detected object. A sensing direction 49 of the optical sensor 48 is oriented downwards, in particular vertically downwards. The base body 34 has a viewing window 50 through which the optical sensor 48 can detect the respective object.

The operating device 22 has a temperature sensor 51. The temperature sensor 51 is designed as an infrared thermometer for contactless detection of the temperature of a supporting body that is arranged in particular below the operating device 22. The supporting body is understood to be a body on which the operating device 22 can be placed, in particular in one of the operating positions 23, 24. For example, the cooking product carrier 15 or the kitchen worktop 19 can serve as the supporting body. Preferably, the temperature sensor 51 is designed to detect temperatures in a range from −20° C. to 300° C. The temperature sensor 51 is in signal connection with the processor 26.

The operating device 22 has a position sensor 52 to determine the position of the operating device 22 relative to the kitchen appliance, in particular to the hob system 2 and/or the oven 3. In particular, the position sensor is configured to detect an arrangement of the operating device 22 on a hot plate 13 or at a distance from each or all of the hot plates 13. The position sensor 52 may comprise a receiver for electromagnetic radiation, in particular of a Bluetooth signal or an RFID signal to determine a distance between the operating device 22 and the kitchen appliance 2, 3. The position sensor 52 may comprise a Hall sensor to detect conductive tracks that are arranged in the kitchen appliance 2, 3, in particular on the cooking product carrier 15.

The operating device 22 has a heat protection body 53. The heat protection body 53 is attached to the base body 34 in a replaceable manner, in particular without tools. The heat protection body 53 has a positioning surface 54 on which the operating device 22 can be placed. In the respective operating position 23, 24, the operating device 22 contacts an underlying object on which the operating device 22 is placed, in particular the kitchen worktop 19 or the cooking product carrier 15, exclusively via the positioning surface 54 of the heat protection body 53.

The heat protection body 53 is preferably heat resistant up to at least 250° C. The conductivity of a material of the heat protection body 53 is a maximum of 5 W/mK. In particular, the thermal conductivity is in a range from 0.1 W/mK to 0.5 W/mK. The heat protection body 53 is made of silicone.

For reversible, non-slip arrangement of the operating device 22, in particular on a glass surface, the operating device 22 has an adhesive means 55.

The adhesive means 55 is attached to the base body 34. The adhesive means 55 is configured by a silicone layer, in particular of the heat protection body 53, which comprises the positioning surface 54. The silicone layer causes an increased friction between the operating device 22 and the underlying supporting body, in particular due to a negative pressure effect. The silicone layer can be concave in shape to increase the negative pressure effect.

The operating device 22 has an acoustic signal transmitter 56, in particular a beeper or a loudspeaker. The acoustic signal transmitter 56 in the form of a loudspeaker can be designed to play music, in particular music files stored on the data memory 27. In particular, the acoustic signal transmitter 56 is designed to output a warning signal.

The operating device 22 comprises a vibration motor 57 to output haptically detectable vibration signals. The vibration motor 57 and the acoustic signal transmitter 56 are in signal connection with the processor 26.

The operating device 22 has a switch 58 to switch the operating device 22 on and off, in particular to interrupt the energy-transmitting connection between the energy storage device 28 and the processor 26. The switch 58 is arranged on the underside of the operating device 22. Preferably, the switch 58 is splash-proof, in particular waterproof.

The operating principle of the kitchen appliance system 1, in particular the operating device 22, is as follows:

The operating device 22 and the kitchen appliances 2, 3 are switched off. The kitchen appliances 2, 3 can be activated and controlled via their respective user interface 5, 11. A temperature within the cooking chamber 4 is controllable via the oven user interface 5. The hob user interface controls a power output via the hot plates 13.

The operating device 22 is switched on by actuating the switch 58. The energy storage device 28 supplies the processor 26 with electrical energy. A computer program stored in the data memory 27 is processed by the processor 26.

The communication unit 25 establishes a signal connection to transmit information between the hob control device 12 and/or the oven control device 6 and the operating device 22. The hob system 2, in particular the hob 9 and the extractor fan apparatus 10, and/or the oven 3 can be controlled by means of the operating device 22. In particular, the heating power of the hob 9 and/or the temperature in the cooking chamber 4 of the oven 3 and/or the extraction power of the extractor fan apparatus 10 can be controlled by means of the operating device 22.

The connection between the operating device 22 and the kitchen appliances 2, 3 is wireless. This makes it possible to control the kitchen appliance 2, 3 by means of the portable operating device 22 from different operating positions 23, 24.

Information concerning the control options and/or status parameters of the kitchen appliance 2, 3 are output via the display means 29.

By moving the control element 38 relative to the base body 34 rotationally about the axis of rotation 39 and/or translationally along the axis of rotation 39, user commands can be detected. In particular, menu items can be selected or status parameters of the respective kitchen appliance 2, 3, such as power values, can be set by rotating the control element 38. By translationally moving the control element 38 relative to the base body 34, a confirmation, in particular of a selection or change, can be made.

Furthermore, user inputs are possible via the touch-sensitive screen, in particular the sensor film, of the display means 29. The user inputs are transmitted as control information via the communication unit 25 the respective kitchen appliance 2, 3 in particular to the respective control device 6, 12.

The energy storage device 28 is wirelessly charged with electrical energy by means of the energy receiver 33. For this purpose, the operating device 22 can be arranged on one of the hot plates 13. By means of the energy receiver 33, the electromagnetic energy emitted by the hot plates 13, which are designed as induction cooking plates, can be converted into the electrical energy that can be stored by the energy storage device 28.

When the control element 38 is displaced relative to the base body 34, changes, for example of status parameters or list elements, corresponding to the representation via the display means 29, are output to the user in a haptically detectable manner by means of the electric actuator 41. Based on a corresponding signal from the processor 26, the actuator 41 causes a moment between the base body 34 and the control element 38, which is coupled in particular to the information represented by the display means 29.

The control element 38 can be removed from the base body 34 for cleaning purposes. In doing so, a latching connection between the first base body element 35 and the second base body element 36 must be loosened. After cleaning the control element 38, the latter can be accommodated again between the interlatchable base body elements 35, 36.

The user can enter voice commands via the microphone 46 to control the operating device 22 and the kitchen appliances 2, 3. The voice commands can be evaluated by means of the processor 26, the respective control device 6, 12 or an online service. For evaluation by means of the online service, the operating device 22 can be connected to the Internet, in particular via the Wifi interface of the communication unit 25.

Recipe programs for preparing the cooking products can be processed via the operating device 22. Ingredients can be automatically detected by means of the optical sensor 48. To simplify the processing of the recipe programs, the ingredients that are specified for addition can be automatically detected and the corresponding information can be forwarded to the recipe program.

By means of the temperature sensor 51, the temperature of the cooking products can be detected and/or the temperature of the surface of the supporting body 15, 19 on which the operating device 22 is arranged. The temperature is preferably displayed by the display means 29. In particular, automated control of the kitchen appliance 2, 3 can be performed on the basis of the detected temperature value.

The temperature sensor 51 can be designed to protect the operating device 22 from harmful heat input from the environment. Preferably, a warning signal, in particular a warning tone, a vibration and/or a visual warning signal is output via the display means 29 if the temperature sensor 51 detects a temperature that is harmful to the operating device 22, in particular a temperature above 100° C., in particular above 150° C., in particular above 250° C., in particular once or over a period of at least 1 s, in particular at least 2 s, in particular at least 5 s, in particular at least 10 s.

By means of the orientation sensor 47, an orientation of the operating device 22 is calibrated as described above. This allows information to be displayed via the display means 29 in accordance with a preferred alignment of the display selected by the user, irrespective of the orientation of the base body 34. The preferred alignment can be determined in the course of calibration, for example relative to the kitchen room or the kitchen appliance 2, 3.

The position of the operating device 22 relative to the kitchen appliance is detected by means of the position sensor 52. In particular, it is detected where the operating device 22 is located on the hot plates 13 or next to them, in particular at a distance therefrom. This can prevent the operating device 22 from being exposed to harmful heat from the hot plates 13. When the operating device 22 is positioned on one of the hot plates 13, a warning signal can be emitted via the display means 29, the acoustic signal transmitter 56 or the vibration motor 57.

The heat protection body 53 ensures thermal decoupling of the operating device 22 from hot surfaces, in particular of the supporting body, for example from the hot plates 13. Compared to the sensory detection of the surface temperature by means of the temperature sensor 51 and/or the arrangement of the operating device 22 by means of the position sensor 52, the heat protection by means of the heat protection body 53 takes place passively, i.e. without the use of electrical energy, whereby the heat protection is ensured in a particularly efficient, reliable and robust manner.

The operating device 22 can be used to activate or deactivate the respective kitchen appliance 2, 3. All or a reduced range of functions of the respective cooking appliance 2, 3 can be controlled by means of the operating device 22. After completion of the cooking process, the kitchen appliances 2, 3 can be deactivated by means of a user input via the operating device 22. The operating device 22 can be switched off by actuating the switch 58.

The operating device 22 ensures particularly convenient and safe operation of the respective kitchen appliance 2, 3. Due to the design of the operating device 22 with the control element 38 that can be displaced relative to the base body 34, the operation of the respective kitchen appliance 2, 3 can be carried out intuitively, time-efficiently and at the same time safely. The communication unit 25 ensures wireless signal transmission between the operating device 22 and the respective kitchen appliance 2, 3 and thus flexible control of the kitchen appliances 2, 3 from different, in particular freely selectable, operating positions 23, 24. The design of the operating device 22 with the respective heat protection means 51, 52, 53 prevents harmful heat input to the operating device 22. The operating device 22 is thus particularly safe, robust and reliable in operation.

1. A portable operating device for controlling a kitchen appliance from different operating positions, the portable operating device comprising
a base body,
at least one control element, which is displaceable relative to the base body, for the user to input control information,
at least one sensor, for detecting a relative movement between the at least one control element and the base body, and
a communication unit which is connected to the at least one sensor in a signal-transmitting manner in order to wirelessly transmit, to the kitchen appliance, control information which correlates with the relative movement.

2. The portable operating device according to claim 1, wherein the at least one control element is rotatably mounted relative to the base body, wherein the relative movement which is detectable by the at least one sensor is a rotary movement.

3. The portable operating device according to claim 1, wherein the at least one control element is configured to be ring-shaped.

4. The portable operating device according to claim 1, wherein the at least one control element is reversibly removable from the base body.

5. The portable operating device according to claim 1, wherein that the at least one control element is mounted so as to be movable in translation relative to the base body, wherein the relative movement which is detectable by the sensor is a translatory movement.

6. The portable operating device according to claim 1, comprising an electric actuator to effect at least one of a force and a moment which acts between the at least one control element and the base body.

7. A portable operating device for controlling a kitchen appliance, from different operating positions, the portable operating device comprising
a user interface, for the user to input control information,
a communication unit which is connected to the user interface in a signal-transmitting manner to wirelessly transmit the control information to the kitchen appliance, and
at least one heat protection means to protect the operating device from harmful heat input from the environment.

8. The portable operating device according to claim 7, wherein the at least one heat protection means, has at least one heat protection body to thermally decouple a base body from the environment.

9. The portable operating device according to claim 8, wherein the at least one heat protection body comprises a material which is resistant up to at least 250° C.

10. The portable operating device according to claim 8, wherein the at least one heat protection body comprises a material having a thermal conductivity of at most 5 W/mK.

11. The portable operating device according to claim 8, wherein the at least one heat protection body is replaceably attached to the base body.

12. The portable operating device according to claim 8, wherein the at least one heat protection body comprises an adhesive means for reversible, non-slip arrangement on a glass surface.

13. The portable operating device according to claim 7, wherein the at least one heat protection means comprises a position sensor to determine the position of the operating device relative to the kitchen appliance.

14. The portable operating device according to claim 7, wherein the at least one heat protection means comprises a temperature sensor.

15. The portable operating device according to claim 7, wherein the user interface comprises at least one control element which is displaceable relative to the base body for the input of the control information.

16. The portable operating device according to claim 1, comprising at least one display means for the visual output of information.

17. The portable operating device according to claim 1, comprising at least one microphone to detect acoustic signals.

18. The portable operating device according to claim 1, comprising an orientation sensor to determine the orientation of the operating device.

19. The portable operating device according to claim 1, comprising an energy storage device to store electrical energy.

20. The portable operating device according to claim 1, comprising an energy receiver to wirelessly receive energy to operate the operating device.

21. The portable operating device according to claim 1, comprising an adhesive means for reversibly arranging the operating device on a glass surface in a non-slip manner.

22. The portable operating device according to claim 1, comprising a signal transmitter to warn the user of harmful heat input from the environment.

23. A portable operating device for controlling a kitchen appliance from different operating positions, the portable operating device comprising:
a user interface for a user to input control information; and
a communication unit which is connected to the user interface in a signal-transmitting manner to wirelessly transmit the control information to the kitchen appliance.

24. A kitchen appliance system comprising
at least one cooking appliance for heating cooking products, and
a portable operating device according to claim 1, which is configured to control the at least one cooking appliance.

25. The kitchen appliance system according to claim 24, comprising at least one extractor fan apparatus.

26. The kitchen appliance system according to claim 24, wherein the cooking appliance comprises a kitchen appliance orientation sensor to detect the orientation of the operating device relative to the cooking appliance.

27. The kitchen appliance system according to claim 26, wherein the cooking appliance comprises a cooking appliance position sensor to detect the position of the operating device relative to the cooking appliance.
